(19) United States
(12) Patent Application Publication
(10) Pub. No.: US 2023/0193963 A1
(43) Pub. Date: Jun. 22, 2023

(54) CLUTCH ASSEMBLY WITH ADDITIONAL SUPPORT BEARING; AND DRIVE UNIT

(71) Applicant: Schaeffler Technologies AG & Co. KG, (US)

(72) Inventors: Dominik WEIS, Buhl (DE); Steffen LEHMANN, Ettlingen (DE)

(73) Assignee: Schaeffler Technologies AG & Co. KG, Herzogenaurach (DE)

(21) Appl. No.: 16/966,201

(22) PCT Filed: Jan. 29, 2019
(86) PCT No.: PCT/DE2019/100090

§ 371 Date: Jul. 30, 2020

(30) Foreign Application Priority Data
Feb. 27, 2018 (DE) 102018104361.9

(51) Int. Cl. F16D 25/10; F16D 21/06; F16D 25/08; B60K 6/387; B60K 6/405

(52) U.S. Cl. CPC F16D 25/10; F16D 21/06; F16D 25/082; B60K 6/387; B60K 6/405; F16D 2021/0661

(57) ABSTRACT

A clutch assembly for the powertrain of a motor vehicle, including a housing, a support which is supported in a rotatable manner relative to the housing, an electric machine, the rotor of which is received on the support in a rotationally fixed manner, multiple clutches, each having a clutch component that is received on the support in a rotationally fixed manner, and at least one slave cylinder which acts on one clutch in an actuating manner. A first support bearing which forms part of the mounting of the support is arranged directly between the support and the housing, and an additional second support bearing is arranged at a distance from the first support bearing along a rotational axis of the support. A drive unit including the clutch assembly is also provided.

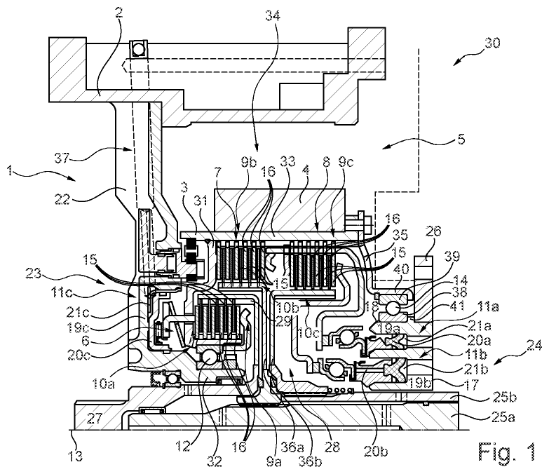

### CROSS-REFERENCE TO RELATED APPLICATIONS

This application is a 371 National Phase of PCT/DE2019/100090, filed Jan. 29, 2019, which claims the benefit of German Patent Application No. 10 2018 104 361.9, filed Feb. 27, 2018.

### TECHNICAL FIELD

The disclosure relates to a clutch assembly (also designated as a hybrid module) for a drivetrain of a motor vehicle such as a passenger car, truck, bus or other utility vehicle, with a housing, with a carrier which is rotatably mounted relative to the housing, with an electric machine received on or fitted to the carrier in torsion-resistant manner with its rotor, with several clutches, each clutch with a clutch component also being received on or fitted to the carrier in torsion-resistant manner, and also with at least one slave cylinder acting in actuating manner on a clutch or on one of the clutches, wherein a first (radial) support bearing jointly forming the mounting of the carrier has been arranged or inserted directly between the carrier and the housing. In addition, the disclosure relates to a drive unit for a drivetrain of a motor vehicle, with this clutch assembly.

### BACKGROUND

Generic clutch assemblies are already sufficiently well-known from the prior art. In this context, WO 2017/008806 A1, for instance, discloses a hybrid module for a drivetrain, and an installation of this hybrid module.

Consequently, various hybrid modules taking the form of triple clutches, the carriers of which are mounted on the housing, are already known from the prior art. However, from previous versions it has turned out to be a disadvantage that the bearing positions on the side of the carrier have frequently been positioned in such a way, and that the housing has been designed to be so stiff, that the rotor of the electric machine changes its radial position in some operating states. This has the consequence that an air gap of the electric machine—that is to say, an air gap between the rotor and a stator of the electric machine—can be influenced. The drive power of the electric machine is also adversely affected thereby.

### SUMMARY

It is therefore an object of the present disclosure to eliminate the disadvantages known from the prior art and, in particular, to make a clutch assembly available that guarantees a support of the rotor that is as robust as possible over its entire operation.

In accordance with the disclosure, this object is achieved by the carrier being equipped with a further, second (radial) support bearing arranged along an axis of rotation of the support (that is to say, in the axial direction of the support), spaced from the first support bearing.

As a result, the carrier and also the rotor coupled with this carrier are radially supported in distinctly more stable manner in operation via two support bearings. In operation, the rotor therefore has distinctly less tendency to change a spacing relative to the stator of the electric machine.

Further advantageous embodiments are claimed with the dependent claims and elucidated in more detail in the following.

If the first support bearing is arranged toward a first axial side alongside several friction elements of one of the clutches, and the second support bearing is arranged toward a second axial side, facing away from the first axial side, alongside the friction elements of the clutch, the carrier and the rotor are supported even more robustly.

The first support bearing takes the form either of a pure radial bearing or, more preferably, of an axial and radial bearing. The second support bearing also takes the form either of a pure radial bearing or, more preferably, of an axial and radial bearing.

The first support bearing and/or the second support expediently take(s) the form of a ball bearing (more preferably, a deep-groove ball bearing).

Furthermore, it is advantageous if the second support bearing has been inserted between the carrier and an actuator housing of the at least one slave cylinder. By virtue of the integration of the second support bearing on the actuator housing, further axial construction space is saved.

In this context it is also an advantage if the second support bearing has been (directly) inserted between the carrier and a radial outside of the actuator housing. As a result, an accommodation of the second support bearing on the actuator housing can be formed relatively easily.

It is also expedient if the actuator housing exhibits two slave cylinders, in which case two fluid chambers of the slave cylinders, each delimited by a housing region and a piston, have been nested in the radial direction—that is to say, arranged offset relative to one another (preferably coaxially relative to one another) in the radial direction. As a result, the actuations for two clutches can be arranged particularly adroitly.

It is advantageous, in addition, if the second support bearing is arranged in the axial direction so as to be at least partially overlapping (that is to say, at the same axial level) with a fluid chamber of the at least one slave cylinder. As a result, the demand for axial construction space is lowered further.

If the first support bearing is received on a partition of the housing extending in the radial direction past the rotor and/or past several friction elements of at least one clutch or of several clutches, a compact design of the housing is employed.

In this context, it is also expedient if a fluid supply of an actuating unit actuating a first clutch is provided, at least sectionally, in the partition.

In addition, the disclosure relates to a drive unit for a drivetrain of a motor vehicle, with a clutch assembly according to the disclosure as specified in at least one of the versions described above and also with a transmission device, wherein at least one transmission input shaft of the transmission device is connected in torsion-resistant manner to a clutch component of a clutch of the clutch assembly.

In this context, it is also beneficial for the installation if the transmission device includes a transmission housing firmly connected to the housing of the clutch assembly and if the at least one slave cylinder is received on a region that is fixed with respect to the transmission housing.

The actuator housing has advantageously been fitted directly or (indirectly) via a connecting element, such as an intermediate plate, to the region that is fixed with respect to the transmission housing.

Expressed in other words, in accordance with the disclosure a triple clutch (three clutches) with additional mounting on the transmission side is consequently realized. In particular, a clutch assembly realized as a hybrid module exhibits a rotor and also a triple clutch, which are supported on their two (axial) sides. A first bearing (first support bearing) is arranged toward an (axial) side that is capable of being connected to an internal-combustion engine, and a second bearing (second support bearing) is provided toward an (axial) side that is capable of being connected to a transmission. The second bearing is supported radially by a double slave cylinder for actuating two partial clutches (second and third clutch) of a double clutch.

### BRIEF DESCRIPTION OF THE DRAWINGS

The disclosure will now be explained in more detail in the following with reference to the FIGURE.

The single FIGURE shows a longitudinal sectional representation of a clutch assembly according to the disclosure.

### DETAILED DESCRIPTION

The FIGURE is merely schematic in nature and serves exclusively for comprehension of the disclosure.

In the FIGURE, the structure of a clutch assembly 1 according to the disclosure as defined by a preferred exemplary embodiment can be readily discerned. The clutch assembly 1 is part of a drive unit 30. In operation, the drive unit 30 is typically employed in a drivetrain of a motor vehicle. The drive unit 30 constitutes a unit consisting of the clutch assembly 1 and a transmission device 24. For the sake of clarity, on the side of the transmission device 24 merely two transmission input shafts 25a, 25b, which are rotatably mounted in a transmission housing of the transmission device 24, have been illustrated. As described in more detail in the following, the clutch assembly 1 has been configured as a hybrid module.

The clutch assembly 1 exhibits a total of three clutches 6, 7, 8. The clutch assembly 1 is therefore also designated as a triple clutch. A first clutch 6 in the form of a separating clutch is arranged on the side of an input of the clutch assembly 1. The input of the clutch assembly 1 is the region that in operation is rotationally coupled with an internal-combustion engine which for the sake of clarity has not been represented. A second clutch 7 and also a third clutch 8 together form a double clutch which interacts further with the two transmission input shafts 25a, 25b.

On the input side of the clutch assembly 1 an input part 27 is provided. In operation, the input part 27 (also designated as a connecting part or intermediate part) is directly or indirectly connected in torsion-resistant manner to an output shaft of the internal-combustion engine. The input part 27 has been either directly fitted in torsion-resistant manner to the output shaft of the internal-combustion engine or indirectly coupled with or connected to the output shaft by a torsional-vibration damper such as a dual-mass flywheel. The input part 27 is rotatably mounted on a housing 2 of the clutch assembly 1. The input part 27 protrudes from an axial outside of the housing 2 (also designated as the clutch housing) into an interior space 28 of the housing 2. In particular, the input part 27 protrudes through a partition 22 of the housing 2 extending in the radial direction.

In the interior space 28 the input part 27 jointly forms a first clutch component 9a of the first clutch 6. For this purpose, the input part 27 exhibits a load-carrying region 29 of the first clutch component 9a of the first clutch 6. Several first friction elements 15 of the first clutch 6 are received on the load-carrying region 29 in torsion-resistant manner and also so as to be slidable in the axial direction relative to one another. Several second friction elements 16 are provided on a further, second clutch component 10a of the first clutch 6. The second friction elements 16 of the first clutch 6 are received on a carrier 3 in torsion-resistant manner and also so as to be axially slidable relative to one another. Consequently, the second clutch component 10a of the first clutch 6 is received on the carrier 3. The carrier 3 exhibits a first support section 31 extending in the radial direction, which first support section 31 forms or receives this second clutch component 10a of the first clutch 6. The first support section 31 is directly supported or mounted on the housing 2 or on the partition 22 in the radial direction by a first support bearing 12. For this purpose, the partition 22 forms a load-carrying section 32 covering the friction elements 15, 16 of the first clutch 6 in the axial direction from radially inside. The first support bearing 12 is arranged in a radial interspace between the load-carrying section 32 and a radial inside of the first support section 31. The first support bearing 12 itself is arranged radially within the friction elements 15, 16 of the first clutch 6. The first support bearing 12 is also axially supported by the first support section 31 and also by the housing 2 in such a way that it acts as a thrust bearing.

The second support region 31 is furthermore connected in torsion-resistant manner further in torsion-resistant manner to a (sleeve-like) receiving section 33 of the carrier 3, extending in the axial direction. For this purpose, the first support section 31 in this version has been welded to the receiving section 33. A rotor 4 of an electric machine 5, which is likewise a component of the clutch assembly 1, is directly received in torsion-resistant manner on the receiving section 33. The rotor 4 has been fastened on a radial outside of the receiving section 33. A stator 34 of the electric machine 5, with respect to which the rotor 4 is capable of being rotated, is firmly connected to the housing 2 or firmly received in the housing 2. Consequently, the electric machine 5 with its rotor 4 is arranged coaxially with respect to an axis of rotation 13 about which the carrier 3 is rotatably mounted and to which the radial and axial directions being used are referred.

A further, second support section 35 of the carrier 3 is arranged on an end of the receiving section 33 facing axially away from the first support section 31. Like the first support section 31, this second support section 35 also extends inward from the receiving section 33 in the radial direction. In this version, the second support section 35 has been fitted onto the receiving section 33 by a screw joint.

In accordance with the disclosure, a second support bearing 14 which is positioned so as to be spaced from the first support bearing 12 in the axial direction, has been arranged on the carrier 3, namely on the second support section 35. Like the first support bearing 12, the second support bearing 14 also takes the form of a ball bearing. In principle, however, it is also possible to design the two support bearings 12, 14 in a different way. Like the first support bearing 12, the second support bearing 14 has also been configured as an axial and radial bearing. Consequently, in operation the carrier 3 is radially supported or mounted via two support bearings 12, 14 spaced from one another in the axial direction.

The carrier 3 is also connected to the two further clutches 7, 8. The carrier 3, namely the receiving section 33, directly receives a first clutch component 9b, 9c of the second clutch 7 and of the third clutch 8.

Accordingly, a first clutch component 9b of the second clutch 7 is received directly on a radial inside of the receiving section 33. Several first friction elements 15 of the second clutch 7 are received on the carrier 3 or on the receiving section 33 in torsion-resistant manner and also so as to be axially slidable relative to one another. A second clutch component 10b of the second clutch 7 has further been connected in torsion-resistant manner to a first transmission input shaft 25a of the transmission device 24. The second clutch component 10b of the second clutch 7 exhibits several (second) friction elements 16 which have been fitted to a first friction-element carrier 36a (of the second clutch component 10b) in torsion-resistant manner and also so as to be axially slidable relative to one another. The first friction-element carrier 36a has further been directly connected in torsion-resistant manner to the first transmission input shaft 25a.

The third clutch 8 has been configured in a manner corresponding to the second clutch 7. The third clutch 8 with its friction elements 15, 16 has been arranged, viewed in the axial direction, alongside the friction elements 15, 16 of the second clutch 7. In addition, the second clutch 7 with its friction elements 15, 16 has been arranged radially outside the friction elements 15, 16 of the first clutch 6. The friction elements 15, 16 of the third clutch 8 have also been arranged radially outside the friction elements 15, 16 of the first clutch 6. A first clutch component 9c of the third clutch 8 is received directly on the carrier 3 or on the receiving section 33. The first clutch component 9c, like the first clutch component 9b of the second clutch 7, has been provided directly on the radial inside of the receiving section 33. Several first friction elements 15 of the third clutch 8, which are an integral part of the first clutch component 9c, are received on the receiving section 33 in torsion-resistant manner and also so as to be axially slidable relative to one another. A second clutch component 10c of the third clutch 8 exhibits several second friction elements 16 which are received on a second friction-element carrier 36b of the third clutch 8 in torsion-resistant manner and also so as to be axially slidable relative to one another. The second friction-element carrier 36b has further been connected to the second transmission input shaft 25b.

The friction elements 15, 16 of the respective clutches 6, 7, 8 alternate in the axial direction for each clutch 6, 7, 8. In a closed position of the respective clutch 6, 7, 8, the friction elements 15, 16 thereof have been pressed against one another in the axial direction in frictionally engaged manner, so that a torsion- resistant bond of the respective first clutch component 9a, 9b, 9c with the second clutch component 10a, 10b, 10c arises. In an open position of the respective clutch 6, 7, 8, the friction elements 15, 16 thereof have then been spaced relative to one another in such a way that the first clutch component 9a, 9b, 9c thereof has been rotationally decoupled from the second clutch component 10a, 10b, 10c.

With regard to the positioning of the two support bearings 12, 14 relative to one another and also relative to the friction elements 15, 16, it can be discerned that the first support bearing 12 has been arranged completely toward a first axial side alongside the friction elements 15, 16 of the third clutch 8. The second support bearing 14, on the other hand, has been arranged completely toward a second axial side, facing away from the first axial side, of these friction elements 15, 16 of the third clutch 8. Since the first support bearing 12 with its components (bearing rings and rolling elements) at least partially (radially from inside) covers or overlaps the friction elements 15, 16 of the first clutch 6 and also of the second clutch 7 in the axial direction, the first support bearing 12 has been arranged offset toward the first axial side only in relation to some friction elements 15, 16 of the second and third clutch 7, 8. The second support bearing 14, however, has been arranged offset toward the second axial side for all the friction elements 15, 16 of the second and third clutches 7, 8.

An actuating unit 23 has been provided for actuating the first clutch 6. The actuating unit 23 exhibits a slave cylinder 11c which has been configured as a concentric slave cylinder. This slave cylinder 11c, designated as the third slave cylinder 11c, has been configured as a hydraulic slave cylinder 11c. With regard to its (third) fluid chamber 21c, the third slave cylinder 11c has been linked to a fluid supply or hydraulic supply. This fluid supply has been partially formed in the partition 22. In particular, a conduit 37 of this fluid supply has been integrated within the partition 22. Consequently, since the partition 22 projects in the radial direction beyond the rotor 4 and also the friction elements 15, 16 of the clutches 6, 7, 8, in operation a fluid is introduced from a radial outside of the rotor 4 or of the electric machine 5 into a radial region of the first clutch 6. A (third) piston 20c forming the third fluid chamber 21c together with a (third) housing region 19c is slidably received in the partition 22. As a result, the actuating unit 23 serves for adjusting the first clutch 6 between its open and closed positions.

For the purpose of actuating the second clutch 7 and also the third clutch 8, in this version a slave-cylinder unit in the form of a double slave cylinder—that is to say, with two slave cylinders 11a, 11b integrated with one another in a module—has been realized. A first slave cylinder 11a actuating the second clutch 7 has consequently been formed together with a second slave cylinder 11b actuating the third clutch 8. Both slave cylinders 11a, 11b are received together in an actuator housing 17. Accordingly, a first housing region 19a and a second housing region 19b of the slave cylinders 11a, 11b have been integrated together in the actuator housing 17. A (first or second, respectively) piston 20a, 20b is slidably guided both in the first housing region 19a and in the second housing region 19b, which together with the (first or second) housing region 19a or 19b, respectively, forms a (first or second) fluid chamber 21a, 21b. The two slave cylinders 11a, 11b—that is to say, the housing regions 19a, 19b of the two slave cylinders 11a, 11b—are arranged in radially nested manner relative to one another. A first housing region 19a of the first slave cylinder 11a is arranged radially outside a second housing region 19b of the second slave cylinder 11b. Since each slave cylinder 11a, 11b takes the form of a concentric slave cylinder, the slave cylinders 11a, 11b—that is to say, the housing regions 19a, 19b—are arranged coaxially relative to one another.

As can be discerned in the FIGURE, the second support bearing 14 is arranged, viewed in a radial direction, between the second support section 35 and a radial outside 18 of the actuator housing 17. For this purpose, a first bearing ring 38 of the second support bearing 14 has been fitted (pressed on) in torsion-resistant manner on the outside 18 or on an outside diameter of the actuator housing 17. In addition to an axial side, the first bearing ring 38 is supported on a (radial) ledge 41 (also designated as a shoulder) on the actuator housing 17. A second bearing ring 39, supported by means of a roller bearing relative to the first bearing ring 38, is received (pressed in) in torque-resistant manner on a radial inside of a bearing region 40 of the second support section 35 extending in the axial direction. The second bearing ring 39 is firmly received in the axial direction on the radial inside of the second support section 35 or of the bearing region 40.

The second support bearing 14 is received on the actuator housing 17 in such a way that the fluid chambers 21a, 21b are arranged in the radial direction within the second support bearing 14. In addition, the second support bearing 14 is arranged in the axial direction at the same level as the fluid chambers 21a, 21b. The first bearing ring 38 therefore overlaps the fluid chambers 21a, 21b at least partially in the axial direction.

In this version, the actuator housing 17 is further connected to an intermediate plate 26. In operation, the intermediate plate 26 typically serves for fastening the actuator housing 17 to the transmission housing of the transmission device 24. In principle, it is also possible, according to further versions, to fasten the actuator housing 17 directly to the transmission housing.

Expressed in other words, two bearing positions have consequently been integrated by virtue of the first support bearing 12 and the second support bearing 14 for the rotor 4. A second bearing position (second support bearing 14) of the rotor 4 has consequently also been integrated on the transmission side. The second bearing position 14 of the rotor 4 is more preferably located on an outside diameter (radial outside 18) of the double CSC (concentric slave cylinder) or of the two slave cylinders 11a, 11b. The CSC 11a, 11b is screw-coupled onto the transmission housing or onto an intermediate plate 26. As a result, in operation the second bearing position 14 arises on the transmission side.

The hybrid module (clutch assembly 1) is distinguished, in particular, in that the rotor 4 and the triple clutch 6, 7, 8 have been mounted on both sides. This is evident by virtue of a (first) bearing position 12 on the engine side and a second bearing position 14 on the transmission side. The second bearing position 14 in this case is radially supported on the double CSC 11a, 11b. The double CSC in this case is screwed onto a base plate onto the transmission side. As a result, the partition 22 of the housing 2 is relieved and can be configured to be thinner.

### LIST OF REFERENCE SYMBOLS

1 clutch assembly
2 housing
3 carrier
4 rotor
5 electric machine
6 first clutch
7 second clutch
8 third clutch
9a first clutch component of the first clutch
9b first clutch component of the second clutch
9c first clutch component of the third clutch
10a second clutch component of the first clutch
10b second clutch component of the second clutch
10c second clutch component of the third clutch
11a first slave cylinder
11b second slave cylinder
11c third slave cylinder
12 first support bearing
13 axis of rotation
14 second support bearing
15 first friction element
16 second friction element
17 actuator housing
18 radial outside
19a first housing region
19b second housing region
19c third housing region
20a first piston
20b second piston
20c third piston
21a first fluid chamber
21b second fluid chamber
21c third fluid chamber
22 partition
23 actuating unit
24 transmission device
25a first transmission input shaft
25b second transmission input shaft
26 intermediate plate
27 input part
28 interior space
29 load-carrying region
30 drive unit
31 first support section
32 load-carrying section
33 receiving section
34 stator
35 second support section
36a first friction-element carrier
36b second friction-element carrier
37 conduit
38 first bearing ring
39 second bearing ring
40 bearing region
41 ledge

1. A clutch assembly for a drivetrain of a motor vehicle, the clutch assembly comprising:
a housing;
a carrier rotatably mounted relative to the housing;
an electric machine having a rotor that is received on the carrier in torsion-resistant manner;
several clutches, each said clutch including a clutch component that is received in torsion-resistant manner on the carrier and at least one slave cylinder acting in actuating manner on said clutch;
a first support bearing jointly forming a mounting of the carrier arranged directly between the carrier and the housing; and
second support bearing supporting the carrier that is spaced from the first support bearing along an axis of rotation of the carrier.

2. The clutch assembly as claimed in claim 1, wherein the first support bearing is arranged toward a first axial side alongside several friction elements of one of the clutches, and the second support bearing is arranged toward a second axial side, facing away from the first axial side, alongside friction elements of another one of the clutches.

3. The clutch assembly as claimed in claim 1, wherein the second support bearing is inserted between the carrier and an actuator housing of the at least one slave cylinder.

4. The clutch assembly as claimed in claim 3, wherein the second support bearing is inserted between the carrier and a radial outside of the actuator housing.

5. The clutch assembly as claimed in claim 4, wherein the actuator housing includes two of the slave cylinders, and two fluid chambers, each delimited by a housing region and a piston, of the slave cylinders are arranged nested in a radial direction.

6. The clutch assembly as claimed in claim 1, wherein the second support bearing is arranged in the axial direction at least partially overlapping with a fluid chamber of the at least one slave cylinder.

7. The clutch assembly as claimed in claim 1, wherein the first support bearing is received on a partition of the housing extending in a radial direction past at least one of the rotor or several friction elements of at least one of the clutches.

8. The clutch assembly as claimed in claim 7, further comprising a fluid supply of an actuating unit actuating a first one of the clutches is provided, at least sectionally, in the partition.

9. A drive unit for a drivetrain of a motor vehicle, comprising a clutch assembly as claimed in claim 1 and a transmission, at least one transmission input shaft of the transmission is connected in torsion-resistant manner to a clutch component of one said clutch of the clutch assembly.

10. The drive unit as claimed in claim 9, wherein the transmission includes a transmission housing firmly connected to the housing of the clutch assembly, and the at least one slave cylinder is received on a region that is fixed with respect to the transmission housing.

11. A clutch assembly for a drivetrain of a motor vehicle, the clutch assembly comprising:
a housing;
a carrier rotatably mounted relative to the housing;
an electric machine having a rotor torsionally fixed to the carrier;
a plurality of clutches, each said clutch including a clutch component that is torsionally fixed to the carrier and at least one slave cylinder configured to actuate said clutch;
a first support bearing that supports the carrier arranged directly between the carrier and the housing; and
a second support bearing that supports the carrier that is spaced from the first support bearing along an axis of rotation of the carrier.

12. The clutch assembly as claimed in claim 11, wherein the first support bearing is arranged adjacent to several friction elements of one of the clutches at a first axial side, and the second support bearing is arranged adjacent to friction elements of another one of the clutches at a second axial side.

13. The clutch assembly as claimed in claim 11, wherein the second support bearing is arranged between the carrier and an actuator housing of the at least one slave cylinder.

14. The clutch assembly as claimed in claim 13, wherein the second support bearing is arranged between the carrier and a radial outside of the actuator housing.

15. The clutch assembly as claimed in claim 14, wherein the actuator housing includes two of the slave cylinders, and two fluid chambers of the slave cylinders are arranged nested in a radial direction.

16. The clutch assembly as claimed in claim 11, wherein the second support bearing is arranged in the axial direction at least partially overlapping with a fluid chamber of the at least one slave cylinder.

17. The clutch assembly as claimed in claim 11, wherein the first support bearing is received on a partition of the housing that extends in a radial direction past at least one of the rotor or several friction elements of at least one of the clutches.

18. The clutch assembly as claimed in claim 17, further comprising a fluid supply of an actuating unit configured to actuate a first one of the clutches that is at least partially located in the partition.
